(19) United States
(12) Patent Application Publication
(10) Pub. No.: US 2013/0103458 A1
(43) Pub. Date: Apr. 25, 2013

(54) MARKDOWN OPTIMIZATION SYSTEM USING A REFERENCE PRICE

(71) Applicants: Manish GUPTE, Burlington, MA (US); Peter GAIDAREV, Charlestown, MA (US)

(72) Inventors: Manish GUPTE, Burlington, MA (US); Peter GAIDAREV, Charlestown, MA (US)

(73) Assignee: ORACLE INTERNATIONAL CORPORATION, Redwood Shores, CA (US)

(21) Appl. No.: 13/276,739

(22) Filed: Oct. 19, 2011

(51) Int. Cl. G06Q 30/02

(52) U.S. Cl. 705/7.35

(57) ABSTRACT

A system determines a markdown pricing sequence for a product. The system receives a sequence of future prices as a function of time for the product based at least on business rules. For each price in the sequence, the system determines a reference price for the product, and then determines an increase in revenue using a demand model. The demand model includes a price elasticity variable that uses the reference price instead of a full price. The system then determines if the sequence of future prices is an optimized sequence based at least in part on the determined increase in revenue.

### FIELD

One embodiment is directed generally to a computer system for determining product pricing, and in particular to a computer system that determines optimized product pricing markdowns.

### BACKGROUND INFORMATION

For a retailer or any seller of products, at some point during the selling cycle a determination will likely need to be made on when to markdown the price of a product, and how much of a markdown to take. Price markdowns can be an essential part of the merchandise item lifecycle pricing. A typical retailer has between 20% and 50% of the items marked down (i.e., permanently discounted) and generates about 30-40% of the revenue at marked-down prices.

A determination of an optimized pricing markdown maximizes the revenue by taking into account inventory constraints and demand dependence on time period, price and inventory effects. An optimized markdown can bring inventory to a desired level, not only during the full-price selling period, but also during price-break sales, and maximize total gross margin dollars over the entire product lifecycle.

### SUMMARY

One embodiment is a system that determines a markdown pricing sequence for a product. The system receives a sequence of future prices as a function of time for the product based at least on business rules. For each price in the sequence, the system determines a reference price for the product, and then determines an increase in revenue using a demand model. The demand model includes a price elasticity variable that uses the reference price instead of a full price. The system then determines if the sequence of future prices is an optimized sequence based at least in part on the determined increase in revenue.

### BRIEF DESCRIPTION OF THE DRAWINGS

FIG. 1 is a flow diagram illustrating the general functionality of prior art markdown optimization systems that implement markdown management to maximize the gross margin, revenue, or other parameter for an item/product.

FIG. 2 is a block diagram of a computer system that can implement an embodiment of the present invention for determining optimized markdown pricing using a reference price.

FIG. 3 is a flow diagram of the functionality of the pricing markdown module of FIG. 2 when determining an optimized pricing markdown with a reference price in accordance with one embodiment.

FIG. 4 is a flow diagram used to calculate λ to determine the reference price.

### DETAILED DESCRIPTION

One embodiment is a markdown optimization system that determines an optimized markdown of prices while utilizing a reference price variable in the demand model. The “reference price” is the price that a consumer expects to pay for the product.

In one embodiment, pricing markdown can be determined by solving a “markdown optimization problem.” The objective of the markdown optimization problem can be to find a monotonically decreasing sequence of merchandise prices that maximizes the revenue by taking into account inventory constraints and demand dependence on time period, price and inventory effects.

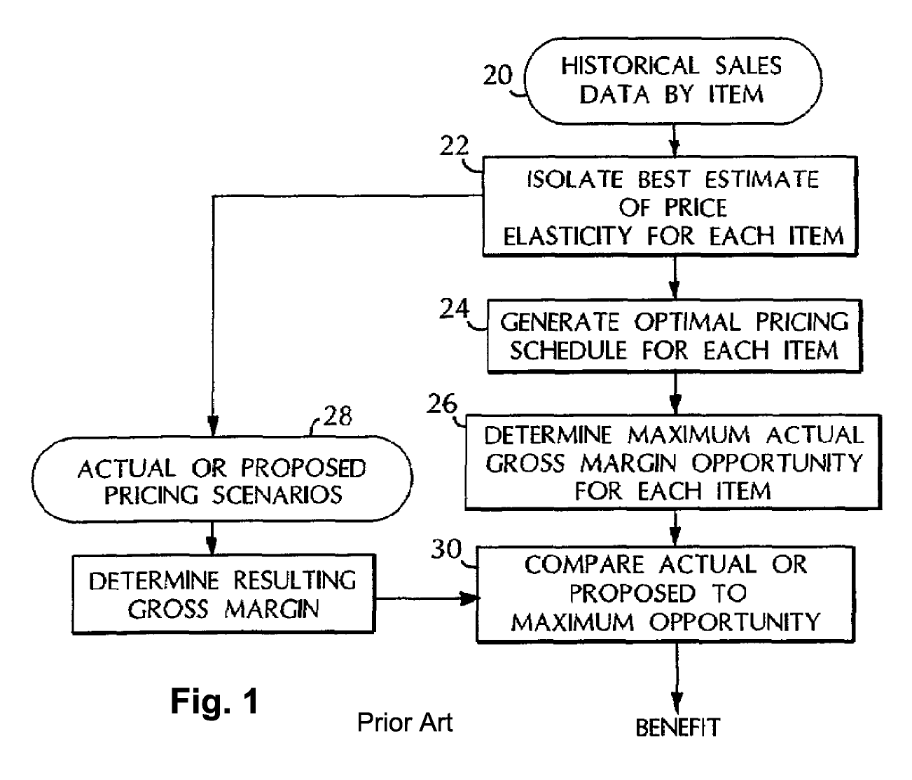

FIG. 1 is a flow diagram illustrating the general functionality of prior art markdown optimization systems that implement markdown management to maximize the gross margin, revenue, or other parameter for an item/product. As shown in FIG. 1, one way to establish an intrinsic maximum gross margin opportunity for an item is to analyze historical information about sales of different items at 20 in order to isolate a best estimate of the price elasticity for each item at 22. Once the best estimate of an item's price elasticity is obtained, the optimal pricing schedule (e.g., markdown scenario) for the item is generated at 24 by searching for an optimal gross margin for the item at 26.

Once this optimal gross margin for an item is determined, historical or proposed in-season pricing schedules 28 can be determined using the price elasticity estimate and can be compared against the maximum opportunity available for that item at 30.

Measuring the absolute maximum gross margin of an item at 26 would require perfect knowledge of consumer demand and price elasticity. In the absence of perfect knowledge, markdown optimizers use as much information as possible to make a best guess estimation of the demand components and price elasticity.

The mathematical formulation of the markdown optimization problem can be defined in one embodiment as:

$$max {\sum }_{t = 1}^{T} {p}_{t} {s}_{t}$$

subject to:

sₜ≦dₜ(I₀,p₁, . . . ,pₜ,d₁, . . . ,dₜ₋₁)∀t=1, . . . ,T

sₜ≦Iₜ₋₁

Iₜ=Iₜ₋₁−sₜ

where:
T is the length of the markdown period, usually measured in weeks;
sₜ is the sales volume in period t;
pₜ is the sales price at period t, which is the decision variable;
Iₜ is the inventory level at the end of time period t, I₀ is given as part of the input; and
dₜ( . . . ) is the demand, which in general is a function of past and present price settings, initial inventory, and demand in previous periods. The objective of the optimization problem in one embodiment is to maximize the total revenue, but a different objective can be used such as maximizing the gross margin, as disclosed in the embodiment of FIG. 1.

In one known pricing markdown optimizer, “Retail Markdown Optimization (MDO)”, version 13.2, from Oracle Corp., a number of simplifying assumptions is made regarding the demand to solve the markdown optimization problem, which results in the following expression for the demand function/model (“Equation 1”):

d(t,p,I)=kdₚ(p)d_{I}(I)s(t)δ(t)=k(p/p_{f})^{γ}(I/I_{c})^{α}s(t)δ(t) (1)

where the components of the demand function are as follows:

Price Effect, dₚ(p): captures the sensitivity of demand to price changes. It is modeled as an isoelastic function of price p with constant elasticity γ<−1, dₚ(p)=(p/p_{f})^{γ} where p_{f} is the full price of the item;

Inventory Effect, d_{I}(I): also known as the “broken-assortment effect”, which occurs when willing-to-pay customers cannot find their sizes/colors. It is modeled as a power function of on-hand inventory I, d_{I}(I)=(I/I_{c})^{α}, where I_{c} is the critical inventory of the item;

Seasonality, s(t): seasonal variation of demand due to holidays and seasons of the year; shared by similar items;

Base demand, k: the scaling coefficient expressing the overall strength of the demand;

Random fluctuations, δ(t): random process expressing the stochastic nature of the consumer demand.

The demand model parameters are fitted by estimating base demand, k, price elasticity, γ, and inventory effect power, α, via regression on multiple sales data points with known price, inventory and seasonality.

In another embodiment, similar to the above embodiment, a causal demand model is used as a base model to represent demand for an item. In this demand model, the overall demand is decomposed into several causal factors: seasonality, intrinsic product life cycle, inventory effect, and price elasticity. The sales rate function is expressed as (“Equation 2”):

S(p,t)=SI(t_{y})PLC(t)R(p)f(I) (2)

where SI(t_{y}) is a time dependent function that expresses the seasonality of demand (e.g., bathing suits are in higher demand in May than in September).

$$PLC ( t ) = N \{ ( t - {t}_{0} ) exp [ - \frac{{( t - {t}_{0} )}^{2}}{2 {t}_{pk}^{2}} ] + C \}$$

is the product life cycle function (e.g., fashion shoes have a peak of demand shortly after sales begin, and the demand trails off over time) where N is a normalization parameter, tₚₖ is a model parameter represents the peak time of the product life cycle function, and C a constant baseline offset model parameter.

The inventory effect function is:

$$f ( I ) = \{ \begin{matrix}\frac{I}{{I}_{c}} , & I < {I}_{c} \\ 1 , & I \geq {I}_{c}\end{matrix} \} , \\ for$$

$$I ( t ) = {I}_{0} - {\int }_{{t}_{0}}^{t} S ( p , t ) d t ,$$

where I(t) is the inventory at time t, the initial inventory is I₀, and the critical inventory level I_{c} is a model parameter—below this number the overall demand goes down by the factor and above this number there is no effect. The inventory effect function expresses the notion that sales are adversely affected when the inventory falls below a critical level.

Price elasticity is a key factor in markdown management. The fact that demand changes in response to a markdown (the “markdown effect”) is a fundamental dynamic principle of markdown management. Therefore, it is important to separate the markdown effect from other components of the demand function.

One known embodiment uses a separable multiplicative time-independent price elasticity model. In this embodiment, the demand model is expressed as (“Equation 3”):

S(p,t)=R(p)B(t;p₀), (3)

where the non-time-dependent price elasticity term is (“Equation 4”):

$$R ( p ; {p}_{0} ) = {( \frac{p}{{p}_{0}} )}^{- γ} , \qquad ( 4 )$$

for a current price p, a full retail price p₀, and a price elasticity parameter γ, and where the time dependent factors are expressed in a single base demand term B(t;p₀), which is the base demand at the full retail price p₀ as a function of time t.

The demand model may be summarized in a single equation, which attempts to capture the effect on demand of changes in price and inventory level, relative to their historical values and independent of all other factors. Relative to the observed price p and inventory level I, the new price p′ affects demand through the price elasticity γ, and the new inventory level I′ affects demand through the inventory effect and its critical inventory level I_{c}:

$${S}^{′} = {S ( \frac{p}{{p}^{′}} )}^{γ} \frac{max ( \frac{{I}^{′}}{{I}_{c}} , 1 )}{max ( \frac{I}{{I}_{c}} , 1 )} ,$$

where S is the original observed sales rate and S′ is a simulated sales rate at price p′ and inventory I′.

As disclosed above, the markdown process starts with an estimation of the demand for an item. One motivation to decreasing prices is that inventory levels fall, which makes stock outs more common and finding goods difficult. This reduces demand and hence requires lower prices to sell adequately. Known markdown optimization system utilize a demand model that takes inventory levels into account.

Another motivation to decreasing prices is that the set of consumers who are willing to pay higher prices is eventually exhausted, requiring a price cut which injects new consumers. One embodiment incorporates this “reference price” into the demand model in order to track how many consumers have been exhausted, and use that information to provide a better markdown price.

The “reference price” variable used in the demand model in embodiments of the present invention is the price consumers typically expect to pay for the product. As an example, the reference price for regular gasoline may be $3.89, but it can fluctuate dramatically in response to the price of crude oil. Therefore, there is an evolution of a reference price, so that as consumers are exposed to pricing changes, their notion of what a “normal” price of the product changes as well.

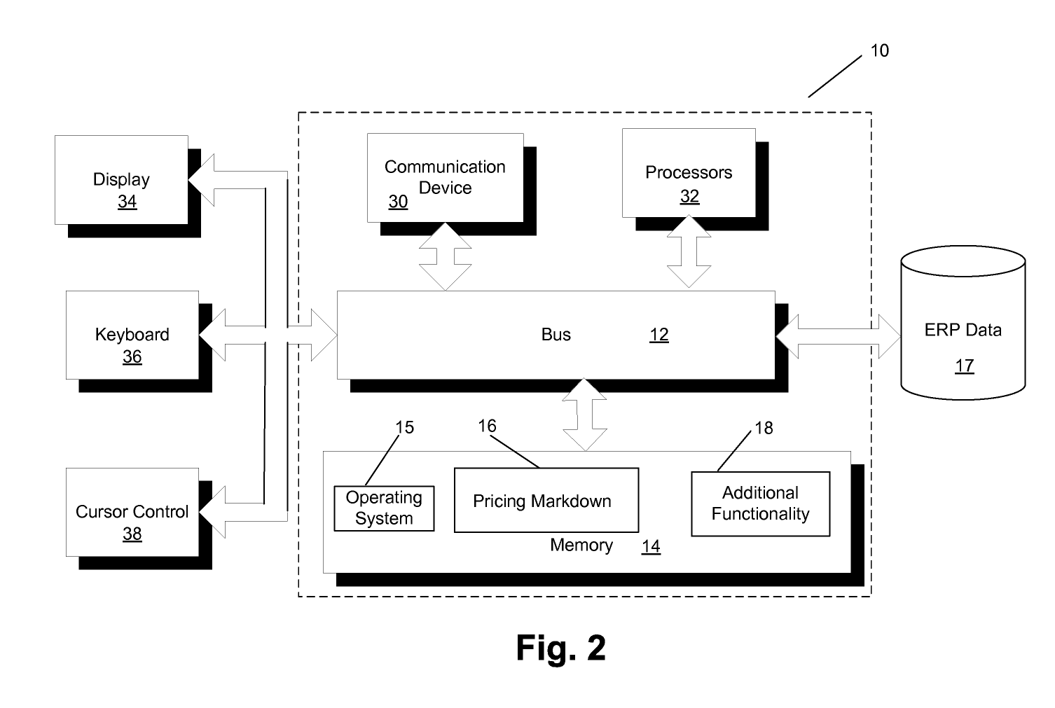

FIG. 2 is a block diagram of a computer system 10 that can implement an embodiment of the present invention for determining optimized markdown pricing using a reference price. Although shown as a single system, the functionality of system 10 can be implemented as a distributed system. System 10 includes a bus 12 or other communication mechanism for communicating information, and a processor 32 coupled to bus 12 for processing information. Processor 32 may be any type of general or specific purpose processor. System 10 further includes a memory 14 for storing information and instructions to be executed by processor 32. Memory 14 can be comprised of any combination of random access memory (“RAM”), read only memory (“ROM”), static storage such as a magnetic or optical disk, or any other type of computer readable media. System 10 further includes a communication device 30, such as a network interface card, to provide access to a network. Therefore, a user may interface with system 10 directly, or remotely through a network or any other method.

Computer readable media may be any available media that can be accessed by processor 32 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 32 is further coupled via bus 12 to a display 34, such as a Liquid Crystal Display (“LCD”), for displaying information to a user. A keyboard 36 and a cursor control device 38, such as a computer mouse, is further coupled to bus 12 to enable a user to interface with system 10.

In one embodiment, memory 14 stores software modules that provide functionality when executed by processor 32. The modules include an operating system 15 that provides operating system functionality for system 10. The modules further include a pricing markdown module 16 that determines an optimized pricing markdown using a reference price, as disclosed in more detail below. System 10 can be part of a larger system, such as an enterprise resource planning (“ERP”) system. Therefore, system 10 will typically include one or more additional functional modules 18 to include the additional functionality. A database 17 is coupled to bus 12 to provide centralized storage for modules 16 and 18 and to store pricing data and ERP data such as inventory information, historical sales data, etc. Database 17 and/or memory 14 can also store business rules that determine a possible sequence of prices for a product, such as a price ladder. For example, a business rule can specify that a brand name product can never be less than 25% more expensive than a generic product, or a product that has a known substitute product (e.g., two different types of sweaters) must always be priced within 10% of each other.

In one embodiment, a reference price variable is included in a markdown optimization demand model, such as the demand models of Equations 1 and 3 disclosed above. The reference price variable is defined as follows (“Equation 5”):

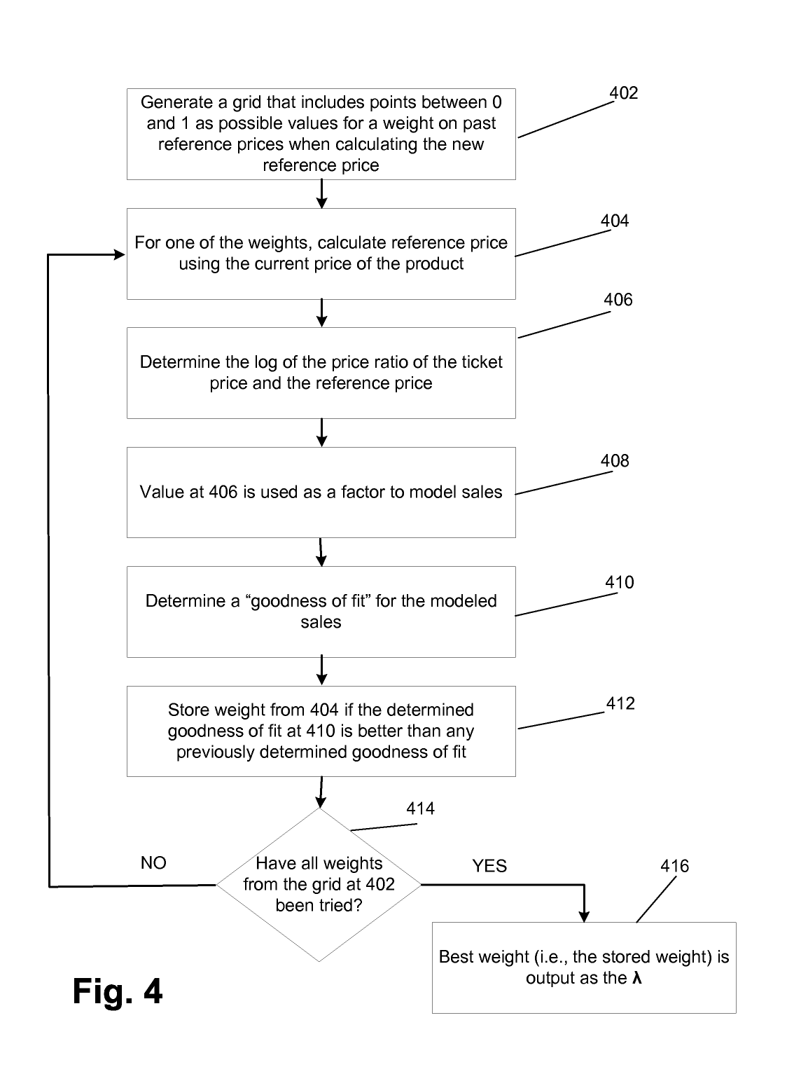

pᵣₜ=λpᵣₜ₋₁+(1−λ)pₜ₋₁, (5)

where pᵣₜ is the current reference price (i.e., at the current time period on the price ladder), pᵣₜ₋₁ is the reference price in the last time period, and pₜ₋₁ is the ticket price in the last time period (i.e., the price indicated on the ticket or tag of the item). λ can be estimated using, for example, the functionality disclosed in conjunction with FIG. 4 below, or it can be configurable. A user may choose to configure λ instead of estimating in order to arrive at a desired markdown pattern.

The reference price is used to determine the price elasticity or price effect, such as the elasticity term of Equation 4 above. Specifically, the price effect used in embodiments of the demand model is modified from (pₜ/p_{f})^{-γ} to (pₜ/pᵣₜ)^{-γ} where p_{f} is the full price of the item and pᵣₜ is the reference price.

In general, rather than computing the sales increase/lift based on difference from the full price, in embodiments of the present invention, the lift is computed as the difference from the reference price. As the reference price is gradually reduced, the lift also becomes lower. Thus, the set of consumers slowly exhausts as the reference price evolves. The reference price reflects the time varying nature of elasticity and models the price response (i.e., lift) falling off with time.

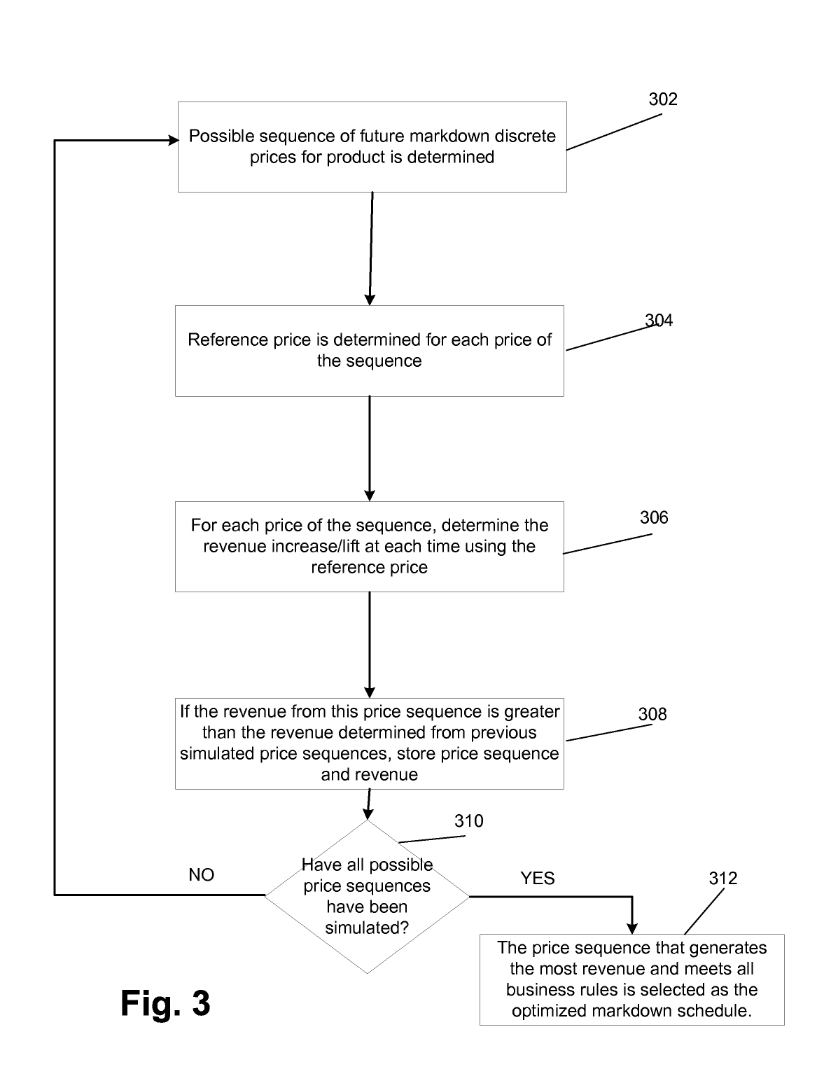

FIG. 3 is a flow diagram of the functionality of pricing markdown module 16 of FIG. 2 when determining an optimized pricing markdown with a reference price in accordance with one embodiment. In one embodiment, the functionality of the flow diagram of FIG. 3, and FIG. 4 below, is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 302, a possible sequence of future markdown discrete prices for the item/product is determined. The sequence can be in the form of a price ladder that defines the sequence of prices as a function of a time period, and is dictated by pre-defined business rules for the product.

At 304, a reference price is determined for each price of the sequence of 302. The reference price is the price that consumers expect to pay for the product. In one embodiment, the reference price is defined as:

pᵣₜ=λpᵣₜ₋₁+(1−λ)pₜ₋₁,

where pᵣₜ is the current reference price, pᵣₜ₋₁ is the reference price in the last time period and pₜ₋₁ is the ticket price in the last time period. λ can be estimated using, for example, the functionality disclosed in conjunction with FIG. 4 below, or it can be configurable. A user may choose to configure λ instead of estimating in order to modify and control the markdown pattern (depth and timing) in accordance with expectations.

At 306, for each price of the sequence, the revenue increase/lift at each time using the reference price is determined. The determination includes using a demand model such as the demand model disclosed above as Equation 2:

S(p,t)=SI(t_{y})PLC(t)R(p)f(I) (2)

For this or any other demand model used by embodiments of the invention, the determined reference price is substituted for the full price when determining the price effect/elasticity R(p) so that (pₜ/p_{f})^{-γ} becomes (pₜ/pᵣₜ)^{-γ}, where p_{f} is the full price of the item and pᵣₜ is the reference price.

At 308, it is determined if the revenue from this price sequence is greater than the revenue determined from previous simulated price sequences starting at 304. If so, the price sequence and revenue is stored. Other predefined business rules can also determine if the price sequence is stored at 308.

At 310, it is determined if all possible price sequences have been simulated. If not, at 302 the next price sequence is determined and then simulated. If yes, at 312 the price sequence that generates the most revenue (or gross margin or other parameter) and meets all business rules is selected as the optimized markdown schedule.

FIG. 4 is a flow diagram used to estimate/calculate λ to determine the reference price that is used in Equation 5 above.

At 402, a grid is generated that includes points between 0 and 1 as possible values for a weight on past reference prices when calculating the new reference price.

At 404, one of the weights is chosen, and the reference price is calculated using the current price of the product and Equation 5 above.

At 406, the log of the price ratio of the ticket price and the reference price is determined.

At 408, the value at 406 is used as a factor to model sales of the item. In one embodiment, the “double difference” method can be used to model sales of the item. The double difference method is disclosed in U.S. patent application Ser. No. 13/101,276, filed May 5, 2011 and entitled “Scalable Regression for Retail Panel Data”.

At 410, a “goodness of fit”, using known statistical measures, is determined for the modeled sales,

At 412, if the determined goodness of fit at 410 is better than any previously determined goodness of fit at 410, the weight from 404 is stored.

At 414, it is determined if all weights from the grid at 402 have been tried. If no, functionality continues at 404 with another weight. If yes at 414, at 416 the best weight (i.e., the stored weight) is output as the λ, and is used to calculate the reference price in Equation 5.

As disclosed, in one embodiment a markdown optimization system generates a sequence of markdown prices that maximize revenue or other desired parameters while taking into account reference pricing. The reference price accounts for a finite set of consumers which are exhausted from prior discounts, and allows for better inter-temporal price discrimination. Embodiments, by using a reference price, cause the optimizer to delay “jumping” to give a markdown after no-touch or inactivity, which results in a more stable sequence of markdowns and an avoidance of unnecessary early and deep markdowns. In general, embodiments cause “higher value” consumers to pay more, and “lower value” consumers to pay less.

Several embodiments are specifically illustrated and/or described herein. However, it will be appreciated that modifications and variations of the disclosed embodiments are covered by the above teachings and within the purview of the appended claims without departing from the spirit and intended scope of the invention.

1. A non-transitory computer readable medium having instructions stored thereon that, when executed by a processor, causes the processor to determine a markdown pricing sequence for a product, the determination comprising:
receive a sequence of future prices as a function of time for the product based at least on business rules;
for each price in the sequence, determine a reference price for the product;
for each price in the sequence, determine an increase in revenue using a demand model, wherein the demand model comprises a price elasticity variable that uses the reference price instead of a full price; and
determine if the sequence of future prices is an optimized sequence based at least in part on the determined increase in revenue.

2. The computer readable medium of claim 1, wherein the reference price comprises a consumer expectation of a price to be paid for the product.

3. The computer readable medium of claim 1, wherein the reference price comprises a determination of substantially high value consumers and substantially low value consumers.

4. The computer readable medium of claim 1, wherein the reference price comprises:
pᵣₜ=λpᵣₜ₋₁+(1−λ)pₜ₋₁,
wherein pᵣₜ is a current reference price, pᵣₜ₋₁ is a reference price in a last time period and pₜ₋₁ is a ticket price in the last time period, and λ is a numeric variable that is configured or estimated.

5. The computer readable medium of claim 1, wherein the price elasticity variable comprises: (pₜ/pᵣₜ)^{-γ}, wherein Pₜ is a ticket price of the product and pᵣₜ is the reference price, and γ is a numeric variable.

6. The computer readable medium of claim 5, wherein the demand model comprises:
S(p,t)=SI(t_{y})PLC(t)R(p)f(I))
and R(p) comprises (pₜ/pᵣₜ)^{-γ}, wherein SI(t_{y}) is a time dependent function of a seasonality of demand, PLC(t) is a product life cycle function, R(p) is a price elasticity function, and f(I) is an inventory effect function.

7. The computer readable medium of claim 4, further comprising calculating λ by:
determine a plurality of possible weights on past reference prices;
for each weight, calculate the reference price;
determine a log of a ratio of a ticket price and the reference price;
model sales of the product using the log; and
choose the λ using a goodness of fit of the model sales.

8. The computer readable medium of claim 4, wherein λ is configurable to modify the sequence of future prices.

9.-13. (canceled)

14. A computer implemented method to determine a markdown pricing sequence for a product, the method comprising:
receiving a sequence of future prices as a function of time for the product based at least on business rules;
for each price in the sequence, determining at a processor a reference price for the product;
for each price in the sequence, determining at the processor an increase in revenue using a demand model, wherein the demand model comprises a price elasticity variable that uses the reference price instead of a full price; and
determining at the processor if the sequence of future prices is an optimized sequence based at least in part on the determined increase in revenue.

15. The method of claim 14, wherein the reference price comprises a consumer expectation of a price to be paid for the product.

16. The method of claim 14, wherein the reference price comprises a determination of substantially high value consumers and substantially low value consumers.

17. The method of claim 14, wherein the reference price comprises:
pᵣₜ=λpᵣₜ₋₁+(1−λ)pₜ₋₁,
wherein pᵣₜ is a current reference price, pᵣₜ₋₁ is a reference price in a last time period and pₜ₋₁ is a ticket price in the last time period, and λ is a numeric variable that is configured or estimated.

18. The method of claim 14, wherein the price elasticity variable comprises:
(pₜ/pᵣₜ)^{-γ}, wherein Pₜ is a ticket price of the product and pᵣₜ is the reference price, and γ is a numeric variable.

19. The method of claim 18, wherein the demand model comprises:
S(p,t)=SI(t_{y})PLC(t)R(p)f(I)
and R(p) comprises (pₜ/pᵣₜ)^{-γ}, wherein SI(t_{y}) is a time dependent function of a seasonality of demand, PLC(t) is a product life cycle function, R(p) is a price elasticity function, and f(I) is an inventory effect function.

20. The method of claim 17, further comprising estimating λ by:
determine a plurality of possible weights on past reference prices;
for each weight, calculate the reference price;
determine a log of a ratio of a ticket price and the reference price;
model sales of the product using the log; and
choose the λ using a goodness of fit of the model sales.

21. The method of claim 17, wherein λ is configurable to control the sequence of future prices.

22.-26. (canceled)

27. The computer readable medium of claim 1, wherein the reference price comprises a measurement of a time variance of elasticity and models a price response as falling off with time.

28. A markdown optimization system for determining a markdown pricing sequence for a product, the system comprising:
a processor;
a memory coupled to the processor and storing instructions that when executed by the processor cause the processor to:
receive a sequence of future prices as a function of time for the product based at least on business rules;
for each price in the sequence, determine a reference price for the product;
for each price in the sequence, determine an increase in revenue using a demand model, wherein the demand model comprises a price elasticity variable that uses the reference price instead of a full price; and
determine if the sequence of future prices is an optimized sequence based at least in part on the determined increase in revenue.

29. The system of claim 28, wherein the reference price comprises a consumer expectation of a price to be paid for the product.

30. The system of claim 28, wherein the reference price comprises a determination of substantially high value consumers and substantially low value consumers.

31. The system of claim 28, wherein the reference price comprises:
pᵣₜ=λpᵣₜ₋₁+(1−λ)pₜ₋₁,
wherein pᵣₜ is a current reference price, pᵣₜ₋₁ is a reference price in a last time period and pₜ₋₁ is a ticket price in the last time period, and λ is a numeric variable that is configured or estimated.

32. The system of claim 31, further comprising estimating λ by:
determine a plurality of possible weights on past reference prices;
for each weight, calculate the reference price;
determine a log of a ratio of a ticket price and the reference price;
model sales of the product using the log; and
choose the λ using a goodness of fit of the model sales.

33. The system of claim 31, wherein λ is configurable to control the sequence of future prices.
